(19) United States
(12) Patent Application Publication
(10) Pub. No.: US 2009/0027276 A1
(43) Pub. Date: Jan. 29, 2009

(54) Linear polarized patch antenna structure

(76) Inventors: Ming-Tsan Tseng, Tainan City (TW); Chun-Chih Yang, Yonghe City (TW); Yueh-Pi Huang, Sanwan Township (TW); Chih-Ming Chen, Neipu Township (TW); Kuan-Sung Lee, Magong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,798

(22) Filed: May 8, 2008

(30) Foreign Application Priority Data
Jul. 23, 2007 (TW) 96212012

(51) Int. Cl. H01Q 1/38

(52) U.S. Cl. 343/700 MS

(57) ABSTRACT

A linear polarized patch antenna structure receives circular polarized signals and offsets polarization loss to improve receiving signals quality. The structure includes a body made of ceramic, a main plate is set on an upper end surface of the body, a ground plate is set on a lower end surface of the body and is insulated from the main plate, and a signal transmitting terminal goes through the body and electronically connects with the main plate. Thus, elements are miniaturized and electric demands of signals received by the antenna are satisfied.

### BACKGROUND OF THE INVENTION

1. Field of the Invention

The present invention relates to a linear polarized patch antenna structure, and more particular to a linear polarized patch antenna receiving circular polarized signals.

2. Description of Related Art

Because of the improvement of wireless communication technology, electronic products increasingly require high quality reception of signals. For example, the United States Federal Communications Commission (FCC) requires that mobile phones and other handsets must be equipped with Global Position System (GPS) receivers. Moreover, global industry requires electronic products to be light, thin, short, small, and have highly integrated ICs to achieve miniaturization. The efficiency of an antenna is an important factor for wireless communication quality. All kinds of antennas of wireless communication system, according to different applications, has different performance requirements, such as wireless mobile phones, whose single function antennas or multifunction antennas may include the functions of wireless communication, locating, digital TV, wireless local area network, etc. A base station has different field shapes and polarization requirements according to different placement locus and environment. In order to be convenient for carrying and have attractive appearance, the size of an antenna is reduced and a multifunction antenna is designed to reduce the number of antennas, and the cost of a device is lowered.

Such as GPS antennas, which strictly require applying characteristic, easy handle, and quantificational performance standard, veracity, startup performance, locating tracking sensitivity and low power waste of products, etc.

Generally, signals include linear polarized signals and circular polarized signals, and the antennas in a receiving and transmitting system have a common polarized mode to transmit signals. However, because circular polarized antennas have large dimensions, it is hard to achieve miniaturization for devices receiving circular polarized signals via circular polarized antennas of the prior art. Moreover, conventional chip antennas receive circular polarized signals, but such chip antennas are easily affected by external impacts and conditions, such as handling by users, placement angles, etc., which may affect the signal receiving performance of the chip antennas. Furthermore, there is a patched inverse F antenna (PIFA), which has big volume, unitary framework must be considered, and the structure is easily affected by circumstance, thus, the signal receiving performance is affected.

Consequently, because of the technical defects of described above, the applicant keeps on carving unflaggingly through wholehearted experience and research to develop the present invention, which can effectively improve the defects described above.

### SUMMARY OF THE INVENTION

The first object of the present invention is to provide a linear polarized patch antenna structure, the body of which is made of ceramic, and a main plate and a ground plate are set on the body, the linear polarized patch antenna structure receives circular polarized signals.

The second object of the present invention is to provide a linear polarized patch antenna structure, which effectively reduces the device size.

The third object of the present invention is to provide a linear polarized patch antenna structure, which improves signal receiving stability, and renders the quality of the received signals independent of exterior circumstances.

For achieving the object described above, the present invention provides a linear polarized patch antenna structure, which includes a body made of ceramic, a main plate is set on an upper end surface of the body, a ground plate is set on a lower end surface of the body and is insulated from the main plate, and a signal transmitting terminal goes through the body and electronically connects with the main plate. The linear polarized patch antenna structure can receive circular polarized signals via changing the antenna structure and the size of the metal layer, and satisfies the electric characteristic, such as impedance, frequency point and bandwidth, etc.

Therein, the main plate and the ground plate includes of metal layers. The signal transmitting terminal electronically connects with a connection point on a circuit board to transmit the circular polarized signals received by the main plate to the interior of the device. Thus, the linear polarized patch antenna structure can provide receiving signals, which have good performance.

The invention, in accordance with detailed description and drawings, is more particularly comprehended. However, the drawings are illustrated to be referred and not limit the present invention.

### BRIEF DESCRIPTION OF THE DRAWINGS

FIG. 1 is a side view illustrating a linear polarized patch antenna structure according to the present invention;

FIG. 2 is a top side view illustrating a linear polarized patch antenna structure according to the present invention;

FIG. 3 is a schematic view illustrating a linear polarized patch antenna structure connecting with a circuit board according to the present invention.

### DETAILED DESCRIPTION OF THE PREFERRED EMBODIMENTS

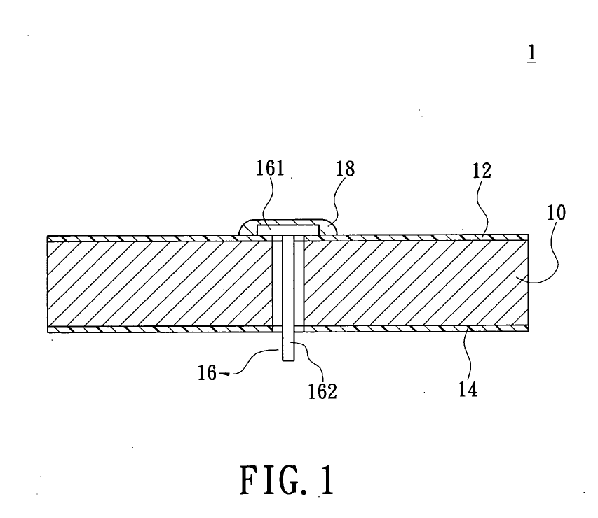

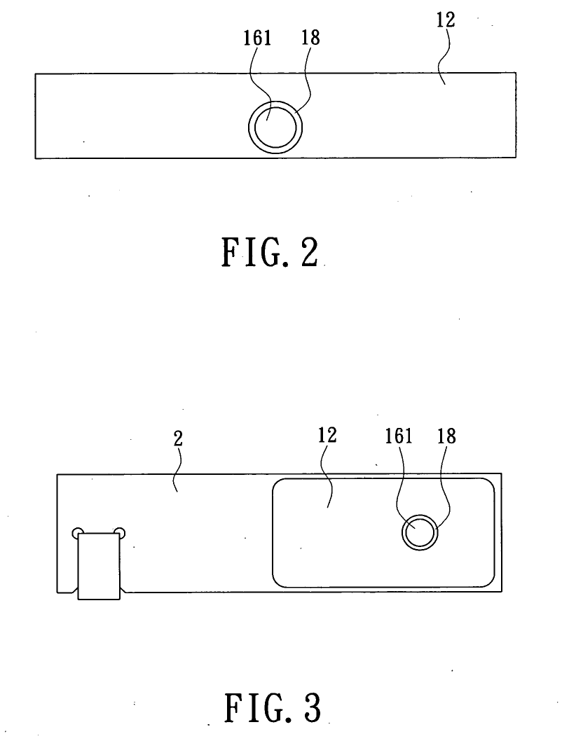

Please refer to FIG. 1 illustrating a linear polarized patch antenna structure according to the present invention. The linear polarized patch antenna structure 1 of the present invention includes a body 10 made of ceramic, a main plate 12, a ground plate 14, and a signal transmitting terminal 16. The linear polarized patch antenna structure 1 receives circular polarized signals. The main plate 12 is fitted on an upper end surface of body 10. The ground plate 14 is fitted on a lower end surface of body 10, and the ground plate 14 is insulated from the main plate 12.

The main plate 12 and the ground plate 14 are metal layers, their material may be silver, and the silver is coated on the body via stencil printing to form silver layers. The metal layers are formed by metal sputtering or other methods.

Moreover, the signal transmitting terminal 16 passes through the body 10 and electronically connects with the main plate 12. In the present embodiment, the signal transmitting terminal 16 is soldered onto the main plate 12 thereby forming a soldered dot 18 is on the main plate 12.

Preferably, the signal transmitting terminal 16 includes a first connecting portion 161, and the first connecting portion 161 may electronically connect with the main plate 12. Furthermore, the signal transmitting terminal 16 extends to form a second connecting portion 162, which electronically connects to a connection point (not shown) on a circuit board. The ground plate 14 must be insulated from the main plate 12 and thus, the second connecting portion 162 must also be insulated from the ground plate 14. Therefore, the metal layer of the ground plate 14 must have a through hole corresponding to through hole in body 10 that accommodates the second connecting portion 162, thereby electronically insulating the second connecting portion 162 from ground plate 14.

The linear polarized patch antenna structure 1 of the present invention also has the functionality of a circular polarized antenna for receiving GPS signals, etc. The linear polarized patch antenna structure 1 may receive space-based signals of satellites via an upper receiving mode, and the field direction is not only perpendicular to ground, but also other at angles in order to receive signals of satellites. Thus, steady signal receiving quality can be provided. Further, the linear polarized patch antenna structure 1 has directivity and maximal gain on the perpendicular face of the radiating element. According to experimental data, the receiving efficiency and the maximal gain of the linear polarized patch antenna structure 1 are all better than that of the chip antenna.

Losses during signal reception, called polarization losses, may occur when the linear polarized patch antenna structure 1 receives circular polarized signals. Thus, the linear polarized patch antenna structure 1 may connect to an exterior circuit or be contained thereinside in order to offset the polarization losses when the linear polarized antenna receives different polarized signals. This further improves the quality of the signal reception of the linear polarized patch antenna structure 1 of the present invention.

Please refer to FIG. 3, the linear polarized patch antenna structure 1 of the present invention may be mounted on a circuit board 2. A connecting point is set on the circuit board 2 correspondingly to the second connecting portion 162, thus, the linear polarized patch antenna structure 1 is mounted on the circuit board 2 to electronically connect with other elements, and the polarization loss is offset to satisfy the electric demands of the circular polarized signals received via the linear polarized patch antenna structure 1, the electric demands are impedance, frequency point and bandwidth, etc. In the present invention, the linear polarized patch antenna structure 1 is rectangular, but it may also be square or have other shapes according to the device in which it is mounted. The linear polarized patch antenna structure 1 of the present invention has following advantages:
1. The linear polarized patch antenna structure 1 of the present invention contributes to miniaturization and high performance of element integrated into a larger system.
2. The linear polarized patch antenna structure 1 of the present invention may receive the circular polarized signals, and the polarization loss caused when the linear polarized patch antenna structure 1 receives the circular polarized signals can be offset via adjusting an exterior circuit or an antenna structure.
3. The linear polarized patch antenna structure 1 of the present invention has good stability, and the quality of the receiving signals cannot be affected by exterior circumstance.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A linear polarized patch antenna structure receiving circular polarized signals, comprising:
a body made of ceramic;
a main plate set on an upper end surface of said body;
a ground plate set on a lower end surface of said body being electrically insulated from said main plate; and
a signal transmitting terminal passing through said body and electronically connecting to said main plate.

2. The linear polarized patch antenna structure according to claim 1, wherein said main plate and said ground plate are metal layers.

3. The linear polarized patch antenna structure according to claim 2, wherein said main plate and said ground plate are silver layers.

4. The linear polarized patch antenna structure according to claim 3, wherein said silver coating is applied to said body via stencil printing to form said silver layers.

5. The linear polarized patch antenna structure according to claim 1, wherein said signal transmitting terminal is soldered on said main plate.

6. The linear polarized patch antenna structure according to claim 5, wherein said signal transmitting terminal has a first connecting portion, and the first connecting portion is soldered on said main plate.

7. The linear polarized patch antenna structure according to claim 1, wherein said linear polarized patch antenna structure is electronically connected to a circuit board.

8. The linear polarized patch antenna structure according to claim 7, wherein said signal transmitting terminal extends to form a second connecting portion, which electronically connects to a circuit board.

9. The linear polarized patch antenna structure according to claim 1, wherein said linear polarized patch antenna structure is rectangular.
